(19) United States
(12) Patent Application Publication
(10) Pub. No.: US 2010/0010138 A1
(43) Pub. Date: Jan. 14, 2010

(54) Organic/Inorganic Composite Material and Optical Element

(76) Inventors: Masako Kikuchi, Tokyo (JP); Hiroto Itoh, Tokyo (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/444,566

(22) PCT Filed: Feb. 13, 2007
(86) PCT No.: PCT/JP2007/052479

§ 371 Date: Apr. 6, 2009

(30) Foreign Application Priority Data
Oct. 12, 2006 (JP) 2006-279011

(51) Int. Cl. C08K 3/22; C08K 3/36

(52) U.S. Cl. 524/430; 524/1

(57) ABSTRACT

Disclosed are an organic-inorganic composite material which is small in rate of variation of refractive index with respect to temperature and is excellent in transparency, and an optical element. The organic-inorganic composite material comprises a resin and inorganic microparticles dispersed therein, characterized in that the inorganic microparticles are dispersed in the resin to form dispersion particles in the form of primary particles or in the form in which several primary particles are aggregated, and when particle diameter of the dispersion particles is expressed by D and center-to-center distance between the centers of any of the dispersion particles and a dispersion particle adjacent thereto is expressed by L, the particle diameter D and the center-to-center distance L satisfy the conditions defined by the following formulas (1) and (2). Formula (1) D₅₀≦30 nm, and Formula (2) L_{P}≦30 nm, wherein in formula (1) D₅₀ represents the particle diameter in a number distribution function of the dispersion particles at which the cumulative number reaches 50% of the number of all the dispersion particles and in formula (2) L_{P} represents the center-to-center distance providing a peak in a frequency distribution function of the center-to-center distance L.

### FIELD OF THE INVENTION

The present invention relates to an organic-inorganic composite material, which is small in rate of variation of refractive index with respect to temperature and excellent in transparency and which is used for a lens, a filter, a grating, an optical fiber or a flat optical waveguide, and to an optical element employing the same.

### TECHNICAL BACKGROUND

For an optical information recording medium (hereinafter also referred to simply as medium) such as MO, CD, DVD or the like, devices to read and record information such as a player, a recorder, a drive, and the like are provided with an optical pickup apparatus. The optical pickup apparatus is equipped with an optical unit, in which a light, reflected after the optical information recording medium is exposed to light having a predetermined wavelength produced from a light source, is received with a light receiving element, and the optical element unit possesses optical elements such as a lens and so forth to condense the light on a reflective layer of the optical information recording medium and the light receiving element.

The optical element of the optical pickup apparatus is preferably a plastic as the material in that it is manufactured at low cost according to injection molding or the like. As the plastic for the optical element, there is known a copolymer of cyclic olefin and α-olefin (see, for example, Patent Document 1).

The optical element employing the plastic as a material is required to have an optical stability as in a glass lens. For example, a plastic material for optical use such as cyclic olefin is extremely low in water absorption rate, as compared with PMMA used hitherto as a plastic for a lens, and greatly improves variation of refractive index due to water absorption. However, temperature dependency of an optical property of the plastic material for optical use is still unsolved, and it is greater by one or more orders of magnitude than that of inorganic glass.

In order to solve the above problem of the plastic material for optical use, there is proposed a method in which fine particles are used as fillers. There is proposed an optical product as disclosed, for example in Patent Document 2, in which in order to reduce temperature dependency of refractive index |dn/dT|, fine particles satisfying dn/dT>0 are dispersed in a polymeric host material satisfying dn/dT<0.

Use of a large amount of inorganic microparticles is necessary to reduce |dn/dT| of the optical product as described above having the dispersed fine particles, however, it is supposed that it causes light scattering due to the inorganic microparticles, resulting in lowering of light transmittance. In order to solve this problem, there is proposed a technique as disclosed in Patent Document 3, which controls a particle size distribution of inorganic microparticles dispersed in the resin to reduce lowering of light transmittance. Although different from an object of reducing lowering of light transmittance, there are proposed composite materials disclosed in Patent document 4 comprising an inorganic compound and a thermoplastic resin containing silica-based inorganic fillers, wherein the content of silica-based inorganic fillers, in which the distance between the silica-based inorganic fillers or the aggregates and the silica-based inorganic fillers or the aggregates adjacent thereto is not less than 0.1 μm, is not more than 50%.

### Patent Document 1: Japanese Patent O.P.I. Publication No. 2002-105131 (Page 4)

### Patent Document 2: Japanese Patent O.P.I. Publication No. 2002-207101 (SCOPE OF THE CLAIMS)

### Patent Document 3: Japanese Patent O.P.I. Publication No. 2006-160992 (SCOPE OF THE CLAIMS)

### Patent Document 4: Japanese Patent O.P.I. Publication No. 2004-143364 (SCOPE OF THE CLAIMS)

### DISCLOSURE OF THE INVENTION

### Problems to be Solved by the Invention

The technique disclosed in Patent Document 3 is insufficient in realizing light transmittance in the level of practical use, and the problem is still unsolved. Further, the technique disclosed in Patent Document 4 fails to disclose the size of the aggregates and does not provide an organic-inorganic composite material having high light transmittance.

The present invention has been made in view of the above. An object of the present invention is to provide an organic-inorganic composite material, which is small in rate of variation of refractive index with respect to temperature and excellent in transparency, and an optical element.

### Means for Solving the Above Problems

A first invention to solve the above problems is an organic-inorganic composite material comprising a resin and inorganic microparticles dispersed therein, characterized in that the inorganic microparticles are dispersed in the resin to form dispersion particles in the form of primary particles or in the form in which several primary particles are aggregated, and that when particle diameter of the dispersion particles is expressed by D and center-to-center distance between the centers of any of the dispersion particles and a dispersion particle adjacent thereto is expressed by L, then the particle diameter D and the center-to-center distance L satisfy the conditions defined by the following formulas (1) and (2).

D₅₀≦30 nm (1)

L_{P}≦30 nm (2)

In formula (1) above, D₅₀ represents the particle diameter D in a number distribution function of the dispersion particles at which the cumulative number reaches 50% of the number of all the dispersion particles, and in formula (2), L_{P} represents the center-to-center distance L providing a peak in a frequency distribution function of the center-to-center distance L.

In the organic-inorganic composite material regarding the first invention above, it is preferred that the center-to-center distance L satisfies the condition defined by the following formula (3).

L_{P}≦20 nm (3)

In the organic-inorganic composite material regarding the first invention above, it is preferred that the center-to-center distance L satisfies the condition defined by the following formula (4).

L₉₅≦60 nm (4)

In formula (4), L₉₅ represents the center-to-center distance L providing a cumulative frequency of 95% in the frequency distribution function of the center-to-center distance L.

In the organic-inorganic composite material regarding the first invention above, it is preferred that when the volume fraction of the inorganic microparticles in the organic-inorganic composite material is represented by Φ, the volume fraction Φ satisfies the condition defined by the following formula (5).

0.2≦Φ≦0.6 (5)

In the organic-inorganic composite material regarding the first invention above, it is preferred that the inorganic microparticles are composite oxides comprised of silicon oxide and an oxide of one or more kinds of metals other than silicon.

A second invention is an optical element formed from the organic-inorganic composite material of the first invention.

### EFFECT OF THE INVENTION

The first and second inventions can provide an organic-inorganic composite material, which is small in rate of variation of refractive index with respect to temperature and excellent in transparency, and an optical element (refer to examples described later).

### BRIEF EXPLANATION OF THE DRAWINGS

FIG. 1(a) is a view showing the state in which inorganic microparticles are dispersed as a single particle in a resin.

FIG. 1(b) is a view showing the state in which inorganic microparticles are dispersed as a single particle or its aggregate in a resin.

FIG. 2(a) is a schematic diagram showing a number distribution function of the number of dispersion particles having a particle diameter D with respect to the particle diameter D of dispersion particles.

FIG. 2(b) is a schematic diagram showing a frequency distribution function of a frequency of dispersion particles having a distance L between the centers of the dispersion particles with respect to the distance L between the centers of the dispersion particles.

FIG. 3 is a schematic view showing the inner structure of an optical pickup device.

### EXPLANATION OF NUMERICAL NUMBER

1. Optical pickup device
2. Semiconductor laser oscillator
3. Collimator
4. Beam splitter
5. ¼ wavelength plate
6. Aperture
7. Objective lens (Optical element)
8. Sensor lens group
9. Sensor
10. Two-dimensional actuator
D: Optical disc
D₁: Protective substrate
D₂: Information recording surface

### PREFERRED EMBODIMENT OF THE INVENTION

Next, the preferred embodiment of the invention will be explained in detail.

The organic-inorganic composite material of the invention is one in which inorganic microparticles are dispersed in a resin, and its molding product is applied to an optical element such as an objective lens.

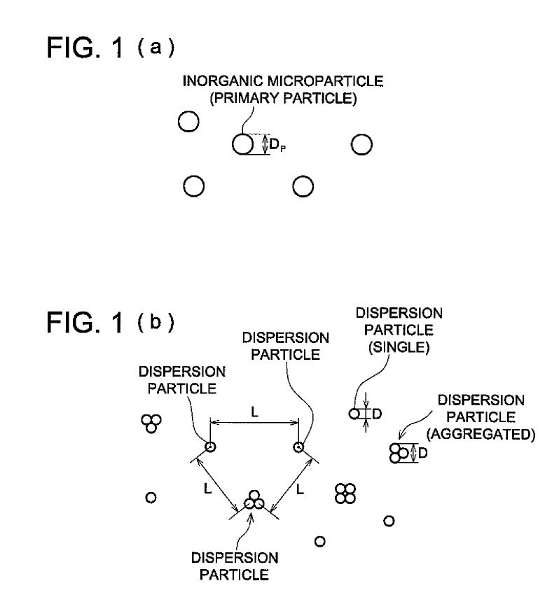

In order to secure transparency and maintain high light transmittance in the organic-inorganic composite material of the invention, it is preferred that the inorganic microparticles are dispersed in the form of primary particles (single particles) as shown in FIG. 1(a). However, as shown in FIG. 1(b), actually, the inorganic microparticles are dispersed in the resin not only in the form of single particles but also in the form of aggregated particles, in which several single particles aggregate, and they are present in the resin as a mixture of single particles and aggregated particles.

When particle diameter of the dispersion particles (including single inorganic microparticles and their aggregates) is expressed by D (see FIG. 1(b)) and center-to-center distance between the centers of any of the dispersion particles and a dispersion particle adjacent thereto is expressed by L (see FIG. 1(b)), the range of the particle diameter D and the range of the center-to-center distance L are extremely important. In the invention, the particle diameter D and the range of the center-to-center distance L satisfy both of the following formulas (1) and (2). The organic-inorganic composite material, when both of the formulas (1) and (2) are satisfied, exhibits excellent transparency and high light transmittance.

D₅₀≦30 nm (1)

L_{P}≦30 nm (2)

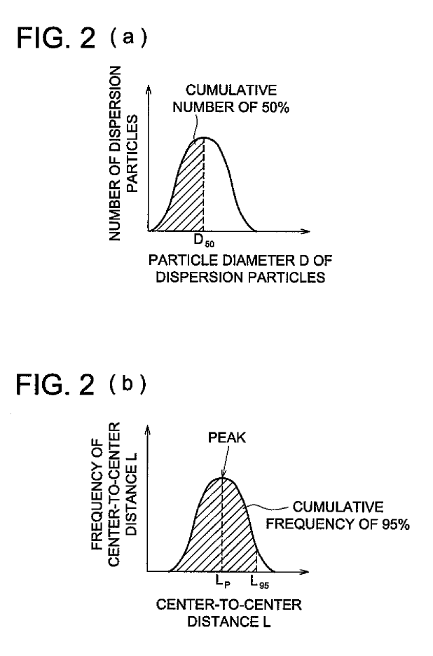

In formula (1) above, when distributions of the particle diameter D of the dispersion particles and the number of the dispersion particles having the particle diameter D are expressed by a function, as shown in FIG. 2(a), D₅₀ represents a particle diameter D in the number distribution function at which the cumulative number of dispersion particles is 50% of the total number of dispersion particles.

As a method of obtaining a number distribution function of dispersion particles, there are a method of preparing a section of an organic-inorganic composite material and image analyzing its transmission electron micrograph, and a method of employing light scattering. In the invention, the number distribution function of dispersion particles is one obtained according to a small angle X-ray scattering method in view of objects to be measured, the range of the particle diameter D, etc. Specifically, the number distribution function is determined by obtaining a small angle X-ray scattering curve employing, as a measuring device (a small and wide angle X-ray scattering device), RINT 2500/PC produced by Rigaku Denki Co., Ltd., and analyzing the small angle X-ray scattering curve, employing, as an analyzing soft, NANO-solver Ver 3.0 produced by Rigaku Denki Co., Ltd.

The particle diameter D₅₀ of the dispersion particles satisfies the condition defined by formula (1) above. However, when the particle diameter D₅₀ exceeds 30 nm, light scattering due to the dispersion particles in a resin is great, resulting in incapability of realizing the effect or object of the invention. In order to increase light transmittance of the organic-inorganic composite material, the particle diameter D₅₀ of the dispersion particles is preferably not more than 20 nm, and more preferably not more than 10 nm.

Herein, when the average primary particle diameter of the inorganic microparticles is expressed by Dp, the average primary particle diameter Dp is preferably from 1 to 30 nm, more preferably from 1 to 20 nm, and still more preferably from 1 to 10 nm. The average primary particle diameter Dp of the inorganic microparticles implies an average of the diameters of spheres having the same volume as the single inorganic microparticles (including those constituting the aggregates), determined from a transmittance electron micrograph of a section of an organic-inorganic composite material in which the inorganic microparticles are dispersed in a resin. When the average primary particle diameter Dp is less than 1 nm, the inorganic microparticles are difficult to disperse in a resin, which has problem in that intended performance is not obtained. Therefore, the average primary particle diameter Dp is preferably not less than 1 nm. On the other hand, when the average primary particle diameter Dp exceeds 30 nm, the resulting organic-inorganic composite material has tendency to be turbid, resulting in lowering of transparency. Therefore, the average primary particle diameter Dp is preferably not more than 30 nm.

Regarding the relationship between the particle diameter D₅₀ of the dispersion particles and the average primary particle diameter Dp of the inorganic microparticles, it is preferred that relationship D₅₀≧Dp is satisfied, and it is more preferred in manufacturing the organic-inorganic composite material that relationship D₅₀≧Dp+1 (nm) is satisfied.

When a distribution of a frequency of the center-to-center distance L between any dispersion particles and a distribution of the center-to-center distance L are expressed by a frequency distribution function as shown in FIG. 2(b), Lp in formula (2) above implies the center-to-center distance L at the peak of the frequency distribution function.

The frequency distribution function of the center-to-center distance L is one obtained according to a small angle X-ray scattering method in the same manner as the number distribution function of the dispersion particles. Specifically, the frequency distribution function of the center-to-center distance L is determined by obtaining a small angle X-ray scattering curve employing, as a measuring device (a small and wide angle X-ray scattering device), RINT 2500/PC produced by Rigaku Denki Co., Ltd., and analyzing the small angle X-ray scattering curve, employing, as an analyzing soft, NANO-solver Ver 3.0 produced by Rigaku Denki Co., Ltd.

The center-to-center distance Lp between the dispersion particles satisfies the condition defined by formula (2) above. When the center-to-center distance Lp exceeds 30 nm, the center-to-center distance L between the dispersion particles is too long, resulting in lowering of light transmittance of the organic-inorganic composite material. The center-to-center distance Lp between the dispersion particles is more preferably not more than 20 nm, and still more preferably not more than 15 nm. It is more preferred in view of manufacture that with respect to the center-to-center distance Lp between the dispersion particles, the relationship Lp≧Dp+1 (nm) is satisfied.

Herein, it is preferred in the organic-inorganic composite material of the invention that the center-to-center distance L between the dispersion particles satisfies the condition defined by formula (4) described later, and the organic-inorganic composite material satisfying this condition exhibits further higher light transmittance.

L₉₅≦60 nm (4)

In formula (4), L₉₅ represents the center-to-center distance L in the frequency distribution function (refer to FIG. 2(b)) of the center-to-center distance L between any dispersion particles and the occurrence frequency of the center-to-center distance L at which a cumulative frequency of the center-to-center distance L is 95%.

The center-to-center distance L₉₅ between the dispersion particles satisfies the condition defined by formula (4) above, but the center-to-center distance L₉₅ between the dispersion particles exceeding 60 nm is likely to cause lowering of light transmittance of the organic-inorganic composite material. The center-to-center distance L₉₅ between the dispersion particles is preferably not more than 40 nm, and more preferably not more than 30 nm.

In the organic-inorganic composite material of the invention, when the volume fraction of the inorganic microparticles in the organic-inorganic composite material is represented by Φ, it is preferred that the volume fraction Φ (=the volume occupied by the inorganic microparticles/the volume of the organic-inorganic composite material) satisfies the condition defined by formula (5) described later, and an organic-inorganic composite material satisfying this condition exhibits high transparency and reduced rate of variation of the refractive index with temperature.

0.2≦Φ≦0.6 (5)

Herein, unless otherwise specified, the volume fraction Φ means the volume fraction at 23° C. The volume fraction Φ of the inorganic microparticles satisfies the condition defined by formula (5) above. The volume fraction Φ of not less than 0.2 provides an organic-inorganic composite material |dn/dT|reduction effect, which is more effective for practical use, and high light transmittance. On the other hand, the volume fraction Φ exceeding 0.6 provides an inflexible organic-inorganic composite material, which is difficult for practical use. Therefore, the volume fraction Φ of the inorganic microparticles is preferably from 0.2 to 0.6, more preferably from 0.25 to 0.5, and still more preferably from 0.3 to 0.5.

In order to obtain the center-to-center distances Lp, L₉₅ above satisfying the condition defined by formula (2), the condition defined by formula (4), respectively, it is necessary to select an average primary particle diameter Dp of the inorganic microparticles and a volume fraction Φ of the inorganic microparticles each falling within an appropriate range and to uniformly disperse the inorganic microparticles in a resin without forming excessively aggregated inorganic microparticles. This can be achieved by controlling the mixing state of a resin and inorganic microparticles to optimize mixing time or torque applied during mixing.

Next, kinds or a manufacturing method of the organic-inorganic composite material will be explained below.

The organic-inorganic composite material of the invention is one in which inorganic microparticles are dispersed in a resin in the form of single or aggregated microparticles as described above. Next, (1) resin, (2) inorganic particles, (3) kinds of additives will be explained, and then (4) a manufacturing method and (5) application of the organic-inorganic composite material will be explained.

The resin used in the invention is not specifically limited as long as it is a transparent resin generally used as an optical material such as a thermoplastic resin, a thermocurable resin or a photocurable resin.

### (1) Resin

The thermoplastic resin used in the invention is preferably a cyclic olefin resin, a polycarbonate resin, a polyester resin, a polyether resin, a polyamide resin, or a polyimide resin in view of its processing suitability as an optical element. A cyclic olefin resin is especially preferred. The compounds disclosed in Japanese Patent O.P.I. Publication No. 2003-73559 can be exemplified. Preferred examples thereof will be listed in Table 1.

TABLE 1

| | | | Abbe |
|---|---|---|---|
| Resin | | Refractive | constant |
| No. | Structure | index n | ν |
| (1) | 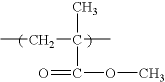 | 1.49 | 58 |
| (2) | 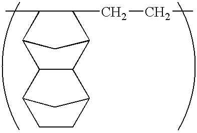 | 1.54 | 56 |
| (3) | 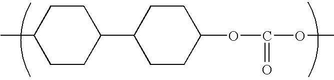 | 1.53 | 57 |
| (4) | 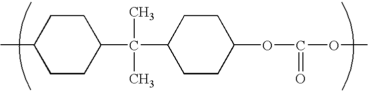 | 1.51 | 58 |
| (5) | 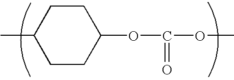 | 1.52 | 57 |
| (6) | 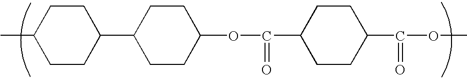 | 1.54 | 55 |
| (7) | 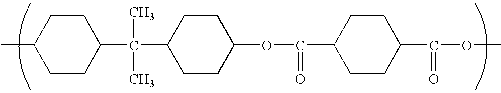 | 1.53 | 57 |
| (8) | 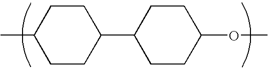 | 1.55 | 57 |
| (9) | 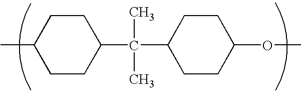 | 1.54 | 57 |
| (10) | 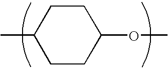 | 1.55 | 58 |
| (11) | 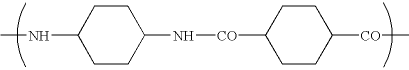 | 1.55 | 53 |
| (12) | 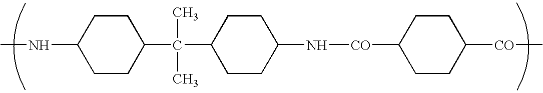 | 1.54 | 55 |
| (13) | 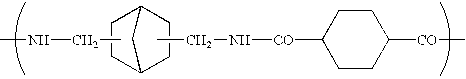 | 1.54 | 56 |
| (14) | 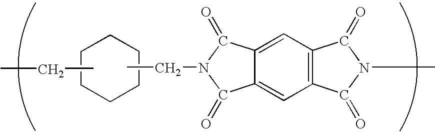 | 1.58 | 43 |

The thermoplastic resins described above have a water absorption rate of not more than 0.2% in view of dimensional stability as an optical material. Therefore, a polyolefin resin (polyethylene, polypropylene), a fluorine-containing resin (polytetrafluoroethylene, Teflon (trade name) AF (produced by Dupont K.K.), a cyclic olefin resin (ZEONEX produced by Nihon Zeon Co., Ltd., APEL produced by Mitsui Kagaku Co., Ltd., ARTON produced by JSR Co., Ltd. and TOPAS produced by Chikona Co., Ltd.), an indene-styrene resin or a polycarbonate resin is preferably used.

### (1.2) Curable Resin (Thermocurable Resin or Photocurable Resin)

The curable resin used in the invention is a resin which is capable of being cured upon ultraviolet or electron beam exposure and is not specifically limited as long as its mixture with inorganic particles can be cured to form a transparent resin composition. As the curable resin are preferably used an epoxy resin, a vinylester resin and a silicone resin. As one embodiment, the epoxy resin and its composition will be explained below, but the invention is not specifically limited thereto.

### (1.2.1) Hydrogenated Epoxy Resin

The curable resins used in the invention include a hydrogenated epoxy resin, and an epoxy resin obtained by hydrogenation of an aromatic epoxy resin is preferably used. Examples thereof include a hydrogenated epoxy resin obtained by hydrogenation of the aromatic ring of a bisphenol A type epoxy resin, a bisphenol F type epoxy resin, a biphenol epoxy resin such as 3,3′,5,5′-tetramethyl-4,4′-biphenol type epoxy resin or 4,4′-biphenol type epoxy resin, a phenol novolac type epoxy resin, an cresol novolac type epoxy resin, a bisphenol A novolac type epoxy resin, a naphthalene diol type epoxy resin, a trisphenylolmethane type epoxy resin, a tetrakisphenylolethane type epoxy resin, and a phenol dicyclopentadiene novolac type epoxy resin. Among these, a hydrogenated epoxy resin obtained by hydrogenation of the aromatic ring of a bisphenol A type epoxy resin, a bisphenol F type epoxy resin or a biphenol epoxy resin is especially preferred in obtaining a hydrogenated epoxy resin with a high hydrogenation rate.

An alicyclic epoxy resin obtained by epoxidation of an alicyclic olefin can be added in an amount of from 5 to 50% by weight in the hydrogenated epoxy resin. As the alicyclic epoxy resin is especially preferred 3,4-epoxycyclohexylmethyl-3′,4′-epoxycyclohexane carboxylate. An epoxy resin composition containing this alicyclic epoxy resin can reduce its viscosity, which results in improvement of the processability.

### (1.2.2) Acid Anhydride Curing Agent

An acid anhydride curing agent in the epoxy resin composition in the invention is preferably an acid anhydride curing agent having no carbon-carbon double bond in the molecule. Typical examples thereof include hexahydrophthalic anhydride, methylhexahydrophthalic anhydride, hydrogenated nadic anhydride, hydrogenated methyl nadic anhydride, hydrogenated trialkyl hexahydrophthalic anhydride, and 2,4-diethylglutaric anhydride. Among these, hexahydrophthalic anhydride and/or methylhexahydrophthalic anhydride are especially preferred in providing excellent heat resistance and colorless cured materials.

The addition amount of the acid anhydride curing agent, although varies due to the epoxy equivalent in the epoxy resin, is preferably from 40 to 200 parts by weight based on 100 parts by weight of epoxy resin.

### (1.2.3) Curing Accelerating Agent

A curing accelerating agent can be used in the epoxy resin composition in the invention in order to promote curing reaction of the epoxy resin and the acid anhydride curing agent. Examples of the curing accelerating agent include tertiary amines and their salts, imidazoles and their salts, organic phosphine compounds, and organometallic salts such as zinc octylate and tin octylate. As the curing accelerating agent are especially preferred organic phosphine compounds. The addition amount of the curing accelerating agent is preferably in the range of from 0.01 to 100 parts by weight based on 100 parts by weight of hydrogenated acid anhydride curing agent. The addition amount of the curing accelerating agent falling outside the above range is undesired since balance between heat resistance and humidity resistance lowers.

### (2) Inorganic Microparticles

The inorganic microparticles used in the invention include oxide microparticles, metal salt microparticles and semiconductor microparticles. Among the aforesaid microparticles, those in which absorption, light emission and fluorescence are not generated in the wavelength area used as an optical element, are properly selected and used.

The following metal oxide is used for oxide microparticles used in the present invention: a metal oxide constructed by one or more kinds of metal selected by a group including Li, Na, Mg, Al, Si, K, Ca, Sc, Ti, V, Cr, Mn, Fe, Co, Ni, Cu, Zn, Rb, Sr, Y, Nb, Zr, Mo, Ag, Cd, In, Sn, Sb, Cs, Ba, La, Ta, Hf, W, Ir, Tl, Pb, Bi and rare earth metal. More specifically, for example, oxide such as silicon oxide, titanium oxide, zinc oxide, aluminum oxide, zirconium oxide, hafnium oxide, niobium oxide, tantalum oxide, magnesium oxide, calcium oxide, strontium oxide, barium oxide, indium oxide, tin oxide, lead oxide; complex oxide compounds these oxides such as lithium niobate, potassium niobate and lithium tantalate, the aluminum magnesium oxide (MgAl₂O₄) are cited.

Furthermore, rare earth oxides are used for the oxide microparticles. Examples thereof include scandium oxide, yttrium oxide, lanthanum trioxide, cerium oxide, praseodymium oxide, neodymium oxide, samarium oxide, europium oxide, gadolinium oxide, terbium oxide, dysprosium oxide, holmium oxide, erbium oxide, thulium oxide, ytterbium oxide, and lutetium oxide. As metal salt microparticles, the carbonate, phosphate, sulfate, etc. are cited. More specifically, calcium carbonate and aluminum phosphate are cited.

Moreover, semiconductor microparticles in the present invention mean the microparticles constructed by a semiconducting crystal. The semiconducting crystal composition examples include simple substances of the 14th group elements in the periodic table such as carbon, silica, germanium and tin; simple substances of the 15th group elements in the periodic table such as phosphor (black phosphor); simple substances of the 16th group elements in the periodic table such as selenium and tellurium; compounds comprising a plural number of the 14th group elements in the periodic table such as silicon carbide (SiC); compounds of an element of the 14th group in the periodic table and an element of the 16th group in the periodic table such as tin oxide (IV) (SnO₂), tin sulfide (II, IV) (Sn(II)Sn(IV)S₃), tin sulfide (IV) (SnS₂), tin sulfide (II) (SnS), tin selenide (II) (SnSe), tin telluride (II) (SnTe), lead sulfide (II) (PbS), lead selenide (II) (PbSe) and lead telluride (II) (PbTe); compounds of an element of the 13th group in the periodic table and an element of the 15th group in the periodic table (or III-V group compound semiconductors) such as boron nitride (BN), boron phosphide (BP), boron arsenide (BAs), aluminum nitride (AlN), aluminum phosphide (AlP), aluminum arsenide (AlAs), aluminum antimonide (AlSb), gallium nitride (GaN), gallium phosphide (GaP), gallium arsenide (GaAs), gallium antimonide (GaSb), indium nitride (InN), indium phosphide (InP), indium arsenide (InAs) and indium antimonide (InSb); compounds of an element of the 13th group in the periodic table and an element of the 16th group in the periodic table such as aluminum sulfide (Al₂S₃), aluminum selenide (Al₂Se₃), gallium sulfide (Ga₂S₃), gallium selenide (Ga₂Se₃), gallium telluride (Ga₂Te₃), indium oxide (In₂O₃), indium sulfide (In₂S₃), indium selenide (In₂Se₃) and indium telluride (In₂Te₃); compounds of an element of the 13th group in the periodic table and an element of the 16th group in the periodic table such as thallium chloride (I) (TlCl), thallium bromide (I) (Tir), thallium iodide (I) (TlI); compounds of an element of the 12th group in the periodic table and an element of the 16th group in the periodic table (or II-VI group compound semiconductors) such as zinc oxide (ZnO), zinc sulfide (ZnS), zinc selenide (ZnSe), zinc telluride (ZnTe), cadmium oxide (CdO), cadmium sulfide (CdS), cadmium selenide (CdSe), cadmium telluride (CdTe), mercury sulfide (HgS), mercury selenide (HgSe) and mercury telluride (HgTe); compounds of an element of the 15th group in the periodic table and an element of the 16th group in the periodic table such as arsenic sulfide (III) (As₂S₃), arsenic selenide (III) (As₂Se₃), arsenic telluride (III) (As₂Te₃), antimony sulfide (III) (Sb₂S₃), antimony selenide (III) (Sb₂Se₃), antimony telluride (III) (Sb₂Te₃), bismuth sulfide (III) (Bi₂S₃), bismuth selenide (III) (Bi₂Se₃) and bismuth telluride (III) (Bi₂Te₃); compounds of an element of the 11th group in the periodic table and an element of the 16th group in the periodic table such as copper oxide (I) (Cu₂O) and copper selenide (I) (Cu₂Se); compounds of an element of the 11th group in the periodic table and an element of the 17th group in the periodic table such as copper chloride (I) (CuCl), copper bromide (I) (CuBr), copper iodide (I) (CuI), silver chloride (AgCl) and silver bromide (AgBr); compounds of an element of the 10th group in the periodic table and an element of the 16th group in the periodic table such as nickel oxide (II) (NiO); compounds of an element of the 9th group in the periodic table and an element of the 16th group in the periodic table such as cobalt oxide (II) (CoO) and cobalt sulfide (II) (CoS); compounds of an element of the 8th group in the periodic table and an element of the 16th group in the periodic table such as triiron tetraoxide (Fe₃O₄) and iron sulfide (IIY) (FeS); compounds of an element of the 7th group in the periodic table and an element of the 16th group in the periodic table such as manganese oxide (II) (MnO); compounds of an element of the 6th group in the periodic table and an element of the 16th group in the periodic table such as molybdenum sulfide (IV) (MoS₂) and tungsten oxide(IV) (WO₂); compounds of an element of the 5th group in the periodic table and an element of the 16th group in the periodic table such as vanadium oxide (II) (VO), vanadium oxide (IV) (VO₂) and tantalum oxide (V) (Ta₂O₅); compounds of an element of the 4th group in the periodic table and an element of the 16th group in the periodic table such as titanium oxide (such as TiO₂, Ti₂O₅, Ti₂O₃ and Ti₅O₉); compounds of an element of the 2th group in the periodic table and an element of the 16th group in the periodic table such as magnesium sulfide (MgS) and magnesium selenide (MgSe); chalcogen spinels such as cadmium oxide (II) chromium (III) (CdCr₂O₄), cadmium selenide (II) chromium (III) (CdCr₂Se₄), copper sulfide (II) chromium (III) (CuCr₂S₄) and mercury selenide (II) chromium (III) (HgCr₂Se₄); and barium titanate (BaTiO₃). Further, semiconductor clusters whose structures are established such as (BN)₇₅(BF₂)₁₅F₁₅, described in Adv. Mater., Vol. 4, p. 494 (1991) to G. Schmid et al.; and Cu₁₄₆Se₇₃(triethylphosphine)₂₂ described in Angew. Chem. Int. Ed. Engl., Vol. 29, p. 1452 (1990) to D. Fenske et al. are cited also.

Refractive index of thermoplastic resins used as optical materials is in the range about 1.4 to 1.6 in many cases, oxide microparticles having an refractive index approximate to the above value are preferably used. Examples of the oxide microparticles include silica (silicon oxide), calcium carbonate, aluminum phosphate, aluminum oxide, magnesium oxide, and aluminum-magnesium oxide. Composite oxide microparticles comprising Si and a metal element other than Si are more preferably used, since it is possible to freely control the refractive index.

The composition distribution of the composite oxide microparticles preferably used in the invention is not specifically limited, and silica and other metal oxides may be substantially uniformly dispersed or in the form of core-shell. Further, the silica and other metal oxides constituting the composite oxide microparticles preferably used in the invention may be present as crystals or as amorphous materials. In the composite oxide microparticles preferably used in the invention, the content ratio of the silica and the other metal oxides can be arbitrarily determined depending on kinds of the metal oxides or the refractive index value of the inorganic microparticles used.

When the composite oxide microparticles have a core/shell structure aluminum oxide, zirconium oxide, titanium oxide and zinc oxide are preferably used as an inner core, since they can form relatively small size particles. Use of silicon oxide as a shell covering the inner core can not only adjust the refractive index of the entire metal oxide microparticles to a specific value but also make it easy to modify the particle surface with an organic compound, whereby restraint of water absorption of the microparticles or high dispersibility in a resin of the microparticles can be achieved. The thickness of the shell is preferably from 1 to 5 nm, and more preferably from 1.5 to 4 nm. The thickness less than 1 nm cannot completely cover the inner core, which does not provide a sufficient surface modification of the microparticles, and the thickness exceeding 5 nm is undesirable, since the material concentration is high during shell formation, which causes aggregation of the particles, and the shell thicknesses of the particles greatly vary, which broadens the refractive index distribution.

In the invention, the inorganic microparticles dispersed in a resin may be used singly or as an admixture of two or more kinds thereof, unless they lower the light transmittance. Use of plural kinds of microparticles having a different property can improve properties to be desired more efficiently.

Further, the form of inorganic microparticles is not specifically limited; however, microparticles having a spherical form are preferably utilized. Specifically, the minimum particle diameter (the minimum value of distances between two tangent lines which are drawn in contact with the circumference of a microparticle)/the maximum particle diameter (the maximum value of distances between two tangent lines which are drawn in contact with the circumference of a microparticle)ᵣ of the particle, is preferably from 0.5 to 1.0, and more preferably from 0.7 to 1.0.

Further, a particle diameter distribution is also not specifically limited; however, those having a relatively narrow distribution rather than those having a broad distribution are preferably utilized.

Further, it is preferred that inorganic microparticles are subjected to a surface treatment. Methods to treat the surface of the inorganic microparticles include a surface treatment by a surface modifier such as a coupling agent, and a surface treatment by polymer grafting or mechanochemical processing.

Examples of the surface modifier used for surface treatment of inorganic microparticles include a silane type coupling agent, silicone oil, and coupling agents of a titanate type, an aluminate type and a zirconate type. These are not specifically limited, however, can be appropriately selected depending on the type of inorganic microparticles and a thermoplastic resin in which the inorganic microparticles are dispersed. Further, two or more different surface treatments can be simultaneously or separately performed.

Examples of a silane type surface treating agent include vinylsilazane trimethylchlorosilane, dimethyldichlorosilane, methyltrichlorosilane, trimethylalkoxysilane, dimethyldialkoxysilane, methyltrialkoxysilane and hexamethyldisilazane, and hexamethyldisilazane is suitably utilized because it can broadly cover the surface of microparticles.

Examples of a silicone oil type surface treating agent include straight silicone oil such as dimethylsilicone oil, methylphenylsilicone oil or methylhydrogensilicone oil; and modified silicone oil such as amino modified silicone oil, epoxy modified silicone oil, carboxyl modified silicone oil, carbinol modified silicone oil, methacryl modified silicone oil, mercapto modified silicone oil, phenol modified silicone oil, one terminal reactive modified silicone oil, different functional group modified silicone oil, polyether modified silicone oil, methylstyryl modified silicone oil, alkyl modified silicone oil, higher fatty acid ester modified silicone oil, hydrophilic specific modified silicone oil, higher alkoxy modified silicone oil, higher fatty acid containing modified silicone oil and fluorine modified silicone oil.

These treating agents may be appropriately diluted with hexane, toluene, methanol, ethanol, acetone, water and the like before use.

Examples of a surface treatment method employing a surface modifying agent include a wet heating method, a wet filtering method, a dry stirring method, an integral blend method and a granulating method. When performing a surface modification of particles with a particle diameter of not more than 100 nm, a dry stirring method is preferably employed in restraining particle aggregation; however, the method surface treatment is not limited thereto.

These surface modifying agents may be utilized alone or as an admixture of plural kinds thereof. Further, since characteristics of surface modified microparticles may differ depending on kinds of a surface modifying agent used, the surface modifying agent, when an organic-inorganic composite material is prepared, can be selected to improve the affinity to a thermoplastic resin to be utilized. The surface modification percentage is not specifically limited, however, is preferably from of 10 to 99% by weight, and more preferably from 30 to 98% by weight, based on inorganic microparticles having been surface modified.

### (3) Additives

Various kinds of additives (referred to also as ingredients) can be added according to necessity during preparation process of the organic-inorganic composite material or during molding process of the organic-inorganic composite material. Examples of the additives include a plasticizer; an anti-oxidant; a light proofing stabilizer; a stabilizing agent such as a thermal stabilizer, a weather proofing stabilizer, a UV absorbent or a near-infrared absorbent; a resin improving agent such as a lubricant; a turbid preventing agent such as a soft polymer or an alcoholic compound; a colorant such as a dye or a pigment; an anti-static agent; a flame retardant; and a filler, though the additives are not specifically limited thereto. These additives may be employed singly or in combination. The adding amount of the additive is suitably determined within the range in which the effects of the present invention are not jeopardized. It is preferred that the polymer contains at least a plasticizer or an antioxidant.

### (3.1) Plasticizer

Though the plasticizer is not specifically limited, a phosphate plasticizer, a phthalate plasticizer, a trimellitate plasticizer, a pyromellitate plasticizer, a glycolate plasticizer, a citrate plasticizer and a polyester plasticizer can be exemplified.

Examples of the phosphate plasticizer include triphenyl phosphate, tricresyl phosphate, cresyl diphenyl phosphate, octyl diphenyl phosphate, diphenyl biphenyl phosphate, trioctyl phosphate and tributyl phosphate; examples of the phthalate plasticizer include diethyl phthalate, dimethoxyethyl phthalate, dimethyl phthalate, dioctyl phthalate, dibutyl phthalate, di-2-ethylhexyl phthalate, butyl benzyl phthalate, diphenyl phthalate and dicyclohexyl phthalate; examples of the trimellitate plasticizer include tributyl trimellitate, triphenyl trimellitate and triethyl trimellitate; examples of pyromellitate include tetrabutyl pyromellitate, tetraphenyl pyromellitate and tetraethyl pyromellitate; examples of glycolate plasticizer include triacetine, tributyline, ethyl phthalyl ethyl glycolate, methyl phthalyl ethyl glycolate and butyl phthalyl butyl glycolate; and examples of the citrate plasticizer include triethyl citrate, tri-n-butyl citrate, triethyl acetylcitrate, tri-n-butyl acetylcitrate and tri-n-(2-ethylhexyl) acetylcitrate.

### (3.2) Antioxidant

As the antioxidant, a phenol antioxidant, a phosphorus antioxidant and a sulfur antioxidant are usable and the phenol antioxidant, particularly an alkyl-substituted phenol antioxidant, is preferred. Addition of such antioxidants to a lens can prevent coloring and strength lowering of the lens due to oxidation degradation, which occurs on lens molding, without lowering the transparency and the heat resistance. These antioxidants may be employed singly or as an admixture of two or more kinds thereof. Though the adding amount of the antioxidant may be optionally determined within the range in which the effects of the present invention are not jeopardized, the amount is preferably from 0.001 to 10 parts by weight, and more preferably from 0.01 to 1 part by weight based on 100 parts by weight of resin used.

Known phenol antioxidants can be employed as the phenol antioxidants. Examples of the phenol antioxidant include acrylate compounds described in Japanese Patent O.P.I. Publication Nos. 63-179953 and 1-168643 such as 2-t-butyl-6-(3-t-butyl-2-hydroxy-5-methylbenzyl)-4-methylphenyl acrylate and 2,4-di-t-amyl-6-(1-(3,5-di-t-amyl-2-hydroxyphenyl)ethyl)phenyl acrylate; alkyl-substituted phenol compounds such as octadecyl-3-(3,5-di-t-butyl-4-hydroxyphenyl propionate, 2,2′-methylene-bis(4-methyl-6-t-butylphenol), 1,1,3-tris(2-methyl-4-hydroxy-5-t-butylphenyl)butane, 1,3,5-trimethyl-2,4,6-tris(3,5-di-t-butyl-4-hydroxybenzyl)benzene, tetrakis methylene-3-(3′,5′-di-t-butyl-4′-hydroxyphenyl propionate)methane namely pentaerythrimethyl-tetrakis(3-(3,5-di-t-butyl-4-hydroxyphenyl propionate)) and triethylene glycol-bis(3-(3-t-butyl-4-hydroxy-5-methylphenyl)propionate; and triazine group-containing phenol compounds such as 6-(4-hydroxy-3,5-di-t-butylanilino)-2,4-bisoctylthio-1,3,5-triazine, 4-bisoctylthio-1,3,5-triazine and 2-octylthio-4,6-bis(3,5-di-t-butyl-4-oxyanilino)-1,3,5-triazine.

Examples of the phosphor antioxidant include monophosphites such as triphenyl phosphite, diphenyl isodecyl phosphite, phenyl diisodecyl phosphite, tris(nonylphenyl) phosphite, tris(dinonylphenyl) phosphite, tris(2,4-di-t-butylphenyl) phosphite and 10-(3,5-di-t-butyl-4-hydroxybenzyl)-9,10-dihydro-9-oxa-10-phosphaphenathlene-10-oxide; and diphosphites such as 4,4′-butylidene-bis(3-methyl-6-t-butylphenyl-di-tridecyl phosphite) and 4,4′-isopropylidene-bis(phenyl-di-alkyl (C12-C15) phosphite). Among them, the monophosphites are preferred, and tris(nonylphenyl) phosphite, tris(dinonylphenyl) phosphite and tris(2,4-di-t-butylphenyl) phosphite are especially preferred.

Examples of the sulfur antioxidant include dilauryl 3,3-thiodipropionate, dimiristyl 3,3-thiodipropionate, distearyl 3,3-thiodipropionate, lauryl stearyl 3,3-thiodipropionate, penterythritol-tetrakis(β-lauryl-thiopropionate) and 3,9-bis(2-dodecylthioethyl)-2,4,8,10-tetraoxaspiro[5,5]undecane.

### (3.3) Light Stabilizer

As a light stabilizer, a benzophenone light stabilizer, a benzotriazole light stabilizer and a hindered amine light stabilizer are cited. In the present invention, the hindered amine light stabilizers are preferably employed from the viewpoint of transparency and anti-coloring property of a lens. Among the hindered amine light stabilizer (hereinafter referred to as HALS), ones having an Mn in terms of polystyrene of preferably from 1,000 to 10,000, more preferably from 2,000 to 5,000, and still more preferably from 2,800 to 3,800 are preferred, the Mn measured by GPC using tetrahydrofuran (THF). HALS having too small Mn has problems in that when a block-copolymer is added with HALS, heat-melted and kneaded, it is difficult to add to the block-copolymer in an intended amount since it evaporates, or in that the processing suitability is lowered since bubbles and silver streaks are produced when a block-copolymer added with HALS is heat-melted and molded.

Furthermore, when a plastic optical element such as a lens is used for long time while a lamp is on, the volatile ingredient is generated in a gas state from the lens. HALS having too large Mn is low in the dispersibility in a block copolymer, so that the transparency of the lens is decreased and its light stabilization-improving effect is lowered, Accordingly, a HALS having the Mn falling within the above range provides a lens having excellent processing stability, low gas generation and high transparency.

Typical examples of the HALS include a high molecular weight HALS in which plural piperidine rings are combined through triazine skeletons such as N,N′,N″,N′″-tetrakis-[4,6-bis-{butyl-(N-methyl-2,2,6,6-tetramethylpiperidine-4-yl)amino}-triazine-2-yl]-4,7-diazadecane-1,10-diamine, a polycondensation product of dibutylamine, 1,3,5-triazine and N,N′-bis(2,2,6,6-tetramethyl-4-piperidyl)butylamine, poly[{(1,1,3,3-tetramethylbutyl)amino-1,3,5-triazine-2,4-di-yl}{(2,2,6,6-tetramethyl-4-piperidyl)imino}hexamethylene-{(2,2,6,6-tetramethyl-4-piperidyl)imino}], a polycondensation product of 1,6-hexanediamine-N,N′-bis(2,2,6,6-tetramethyl-4-piperidyl) and morpholine-2,4,6-trichloro-1,3,5-triazine, or poly[(6-morpholino-s-triazine-2,4-di-yl)(2,2,6,6-tetramethyl-4-piperidyl)imino]-hexamethylene-[(2,2,6,6-tetramethyl-4-piperidyl)imino]; and a high molecular weight HALS in which plural piperidine rings are combined through an ester bond such as a polymeric compound of dimethyl succinate and 4-hydroxy(2,2,6,6-tetramethyl-1-piperidineethanol or a mixed ester of 1,2,3,4-butanetetracarboxylic acid, 1,2,2,6,6-pentamethyl-4-piperidinol and 3,9-bis(2-hydroxy-1,1-dimethylethyl)-2,4,8,10-tetraoxaspiro[5,5]undecane.

Among them, ones having an Mn of from 2,000 to 5,000 such as a polycondensation product of dibutylamine, 1,3,5-triazine and N,N′-bis(2,2,6,6-tetramethyl-4-piperidyl)butylamine, poly[{(1,1,3,3-tetrabutylmethyl)amino-1,3,5-triazine-2,4-diylyl}{(2,2,6,6-tetramethyl-4-piperidyl)imino}-hexamethylene{(2,2,6,6-tetramethyl-4-piperidyl)imino}] and a polymeric compound of dimethyl succinate and 4-hydroxy-2,2,6,6-tetramethyl-1-piperidineethanol are preferred.

### (3.4) Adding Amount

The adding amount of the above additives in the organic-inorganic composite material is preferably from 0.01 to 20 parts by weight, more preferably from 0.02 to 15 parts by weight, and still more preferably from 0.05 to 10 parts by weight, based on 100 parts by weight of polymer. In an organic-inorganic composite material having too a small additive content, light resistance improving effect is not sufficiently obtained, so that when it is used in an optical element such as a lens, coloring is caused on laser exposure. On the other hand, in an organic-inorganic composite material having too a large additive content, a part of the additive volatiles as gas or the additive dispersion property in the resin is lowered, resulting in lowering of the transparency of a lens in which the material is used.

Addition of a compound having the lowest glass transition point of not more than 30° C. to the organic-inorganic composite material can prevent occurrence of white turbid without lowering properties such as transparency, heat resistance and mechanical strength for a long period under high temperature and high humidity condition.

### (4) Manufacturing Method

The organic-inorganic composite material of the invention comprises the resin and inorganic microparticles as described above, and its manufacturing method is not specifically limited.

As a manufacturing method of an organic-inorganic composite material when a thermoplastic resin is used as a resin, there are mentioned a method in which a thermoplastic resin is polymerized in the presence of inorganic microparticles, a method in which inorganic microparticles are formed in the presence of the thermoplastic resin, a method in which inorganic microparticles are dispersed in a solvent for a thermoplastic resin to prepare a dispersion and the solvent is removed from the dispersion, and a method in which inorganic microparticles and a thermoplastic resin provided separately are melt kneaded or they are melt kneaded in the presence of solvent. The organic-inorganic composite material of the invention can be manufactured according to any methods described above. Further, each additive can be added at any stage during the manufacturing process, but the adding timing, which has no adverse effect on the manufacture, can be selected.

Among these, a method in which inorganic microparticles and a thermoplastic resin are provided separately and then mixed during melt-kneading is preferred since it is easy and reduces manufacturing cost. As devices usable in melt-kneading, there are mentioned a sealed type melt-kneading device such as Laboplasto Mill, a brabender, a banbury mixer, a kneader or a role; and a batch type melt-kneading device. Also, sequential melt-kneading devices such as a single-axis extruder and a double-axis extruder can be used for manufacture.

In the manufacturing method of the organic-inorganic composite material, the thermoplastic resin and the inorganic microparticles can be mixed at once and kneaded or can be mixed step-by-step in installments and kneaded. In the latter case, in the melt-kneading devices such as the extruders, a component to be mixed step-by-step can be added from a middle of the cylinder. Also, when after kneading, a component not added in advance except for thermoplastic resin is further mixed and melt-kneaded, it can be mixed at once or can be mixed step-by-step for kneading. The method of mixing in installments can be a method where one component is mixed in several installments, a method where a component is mixed at once and then a different component is added step-by-step, and a method combining the methods thereof.

When an organic-inorganic composite material is manufactured by a melt-kneading method, the inorganic microparticles can be added in the form of powder or aggregates. Alternatively, they can be added in the form of dispersion dispersed in liquid, and when added in the form of dispersion dispersed in liquid, degassing is preferably carried out after kneading.

When the inorganic microparticles are added in the form of dispersion dispersed in liquid, it is preferred that they are added after aggregated particles are dispersed into primary particles. For the dispersion, while various dispersion devices can be used, a bead mill is particularly preferred. The bead is made of various kinds of materials and its size is preferably smaller. The bead size is preferably from 0.001 to 1 mm.

When a curable resin is used as a resin, the organic-inorganic composite material of the invention can be obtained by mixing a monomer for the curable resin, a curing agent, a curing accelerating agent and various additives with appropriately surface-treated inorganic microparticles; and curing the resulting mixture by ultraviolet or electron beam exposure or thermal treatment.

The mixing degree of a resin and inorganic microparticles in the organic-inorganic composite material is not specifically limited, but uniform mixing is preferred in developing the advantageous effect of the invention efficiently. Insufficient degree of mixing has problem that the particle diameter distribution of the inorganic microparticles in the organic-inorganic composite material is difficult to satisfy the condition defined by the invention. Since the particle diameter distribution of inorganic microparticles in a resin greatly depends upon a manufacturing method of the organic-inorganic composite material, it is important to consider properties of a resin and inorganic microparticles to be used and select an optimum manufacturing method.

The organic-inorganic composite material as described above is molded into various molded products. The molding method is not specifically limited. When a thermoplastic resin is used as a resin, a melt molding method is preferably used to obtain a molded product which is excellent in properties such as low double refraction, mechanical strength and dimensional stability. As the melt molding methods, there are mentioned commercially available press molding, commercially available extrusion molding, and commercially available injection molding. Among these, the injection molding is preferred in view of molding property and productivity.

When a curable resin is used as a resin, a mixture of a resin composition containing a monomer for the curable resin, a curing agent and the like with inorganic microparticles is subjected to ultraviolet or electron beam exposure for curing or to thermal treatment, and when the curable resin is a ultraviolet curable or electron beam curable resin, the resin composition after incorporated in a light transmitting mold or coated on an appropriate substrate is subjected to ultraviolet or electron beam exposure for curing. When a resin is a heat curable resin, curing and molding can be carried out through compression molding, transfer molding or injection molding.

### (5) Application

The molded product of the organic-inorganic composite material as described above is applied to an optical element. The molded product can be utilized in various forms such as a spherical form, a bar form, a plate form, a column form, a cylinder form, a tube form, a fiber form, or a film or sheet form, and is applied to various optical elements since it is excellent in low double refraction, transparency, mechanical strength, heat resistance and low water absorption.

For example, the molded products are applied to optical lenses and optical prisms including an image pick lens of a camera; a lens of a microscope, an endoscope and a telescope; an all-optical transmitting lens such as eyeglass lens; a pickup lens for an optical disc such as CD, CD-ROM, WORM (recordable optical disc), MO (rewritable optical disc; optomagnetic disc), MD (mini-disc) or DVD (digital video disc); and a lens in a laser scanning system such as an fO lens for a laser beam printer and a lens for a sensor; and a prism lens in a finder system of a camera.

As other optical applications, there are mentioned a light guide of a liquid crystal display and the like; an optical film such as a polarizer film, a retardation film or a light scattering film; a light diffusion plate; an optical card; and a liquid crystal display element substrate.

Among these, the molded products are preferably used as an optical element such as a pickup lens or a laser scanning system lens, in which low double refraction is required.

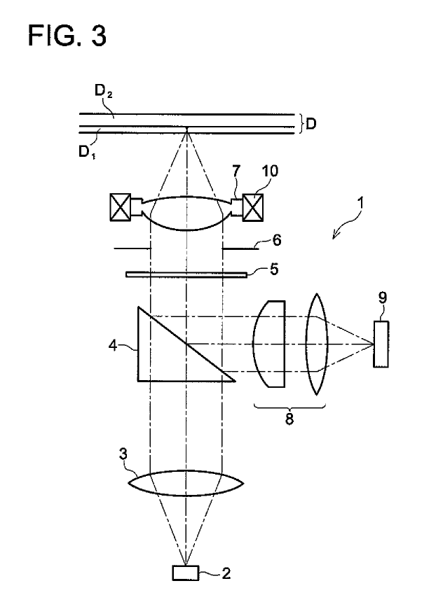

Next, referring to FIG. 3, an optical pickup device 1 will be explained which comprises an optical element molded from the organic-inorganic composite material as described above.

FIG. 3 is a schematic view showing the inner structure of an optical pickup device 1.

The optical pickup device 1 as one embodiment of the invention is equipped with a semiconductor laser oscillator 2 as a light source. A collimator 3, a beam splitter 4, a ¼ wavelength plate 5, an aperture 6, and an objective lens 7 are provided in that order in the direction distant from the semiconductor laser oscillator 2 along the optical axis of a blue light ejected from the semiconductor laser oscillator 2.

A sensor lens group 8 composed of two sets of lens and a sensor 9, each being adjacent to the beam splitter 4, are provided in that order in the direction perpendicular to the optical axis of the blue light.

The objective lens 7 as an optical element is provided so as to face an optical disc D and to converge the blue light ejected from the semiconductor laser oscillator 2 on one surface of the optical disc D. A two-dimensional actuator 10 is attached to the objective lens 7, and the objective lens is freely moved on the optical axis by action of the two-dimensional actuator 10.

Next, function of the optical pickup device 1 will be explained.

As is shown in FIG. 3, the ejected blue light, light L1 passes through the collimator 3, collimated into an infinite parallel light, then passes through the beam splitter 4 and a ¼ wavelength plate 5. Further, the light passes through the aperture 6 and the objective lens 7 to form a converged spot on an information recording plane D₂ via a protective substrate D₁ of an optical disc D.

The light having formed the converged spot is modulated by information pits of the information recording plane D₂ of the optical disc D and reflected by the information recording plane D₂. The resulting reflected light passes through the objective lens 7 and the aperture 6 in that order, and after the polarizing direction being changed by ¼ wavelength plate 9, the light is reflected on the beam splitter 4. Further, the resulting light passes through the sensor lens group 8, is provided with astigmatism, and received on the sensor 9. Finally, the light is subjected to photoelectric conversion by the sensor 9 to be an electric signal.

The above phenomenon is repeated, whereby recording of information to the optical disc D and reproduction of information recorded on the optical disc D are performed.

In the invention, a numerical aperture NA required for objective lens 7 differs depending on the size of information bits or the thickness of the protective substrate D₁ of an optical disc D. In the invention, the optical disc has high density and the numerical aperture is set to 0.85.

### EXAMPLES

Next, referring to Examples, the present invention will be explained in detail, but is not limited thereto.

### Example 1

### (1) Provision and Preparation of Inorganic Microparticles

### (1.1) Provision of Inorganic Microparticles A

Silica (RX300 with an average particle diameter of 7 nm, produced by Nippon Aerosil Co., Ltd.) was provided as Inorganic Microparticles A.

### (1.2) Provision of Inorganic Microparticles B

Silica (RX200 with an average particle diameter of 12 nm, produced by Nippon Aerosil Co., Ltd.) was provided as Inorganic Microparticles B.

### (1.3) Preparation of Inorganic Microparticles C

Ten grams of aluminum oxide (Aluminum oxide C, produced by Nippon Aerosil Co., Ltd.) were added to a mixture solution of 160 ml of pure water, 560 ml of ethanol and 30 ml of ammonia water (25%), and dispersed in an Ultra Apex Mill (produced by Kotobuki Co., Ltd.) to obtain an aluminum particle dispersion solution. A mixture solution of 50 ml of tetraethoxysilane (LS-2430 produced by Shin-etsu Kagaku Co., Ltd.), 16 ml of water and 56 ml of ethanol was dropwise added in 8 hours to the resulting dispersion solution while stirring. Subsequently, the resulting dispersion solution was stirred for additional one hour, then adjusted to a pH of 10.4 with an ammonia water, and stirred for additional 15 hours at room temperature. After that, the resulting dispersion solution was centrifuged to obtain particles. The resulting particles were dried at 190° C. for 15 hours to obtain white powder Inorganic Microparticles C. The average primary particle diameter Dp of the Inorganic Microparticles C was 17 nm, measured through a transmission electron microscope.

### (1.4) Preparation of Inorganic Microparticles D

One hundred gram of a 10% by weight zirconium oxide dispersion solution (Sumitomo Osaka Semento Co., Ltd.) were diluted with 135 ml of water, then dropwise added with 3.7 g of 3-aminopropyltrimethoxysilane, and stirred at 60° C. for 10 hours. The resulting solution was cooled to room temperature, and added with 680 ml of ethanol and 230 ml of ammonia water (28% Kanto Kagaku Co., Ltd.). Subsequently, a mixture solution of 15 g of tetraethoxysilane (produced by Shinetsu Kagaku Co., Ltd.), 200 ml of ethanol and 100 ml of water was dropwise added in 6 hours to the resulting dispersion solution while stirring, and then stirred for additional 12 hours. After that, the resulting dispersion solution was centrifuged to obtain particles. The resulting particles were washed with ethanol, dried at 90° C., and subjected to baking treatment at 450° C. to obtain white powder Inorganic Microparticles D. The average primary particle diameter Dp of the Inorganic Microparticles D was 7 nm, measured through a transmission electron microscope.

### (2) Preparation of Samples

### (2.1) Preparation of Samples 1 Through 4

Samples 1 through 4 were prepared according to a melt kneading method, employing a compound of Chemical Formula 2 in Table 1 as a thermoplastic resin and Inorganic Microparticles A as inorganic microparticles. As a melt kneading apparatus was employed a Laboplasto Mill μ produced by Toyo Seiki Seisakusho Co., Ltd. installed with a segment mixer KF6. The above thermoplastic resin and inorganic microparticles A were introduced in the mixer from the introduction inlet, and kneaded for various kneading times being changed during the period from 1 to 30 minutes. Thus, Samples 1 through 4 were prepared. During kneading, an N₂ gas was introduced in the mixer from the inlet to prevent incorporation of air. With respect to the volume fraction Φ of the inorganic microparticles A to the thermoplastic resin, Samples 1 through 3 were prepared to be Φ=0.3, and Sample 4 was prepared to be Φ=0.2.

### (2.2) Preparation of Samples 5 Through 8

The same thermoplastic resin and melt kneading apparatus as used in item (2.1) above were used. Samples 5 through 8 were prepared in the same manner as above, provided that inorganic microparticles B were used instead of inorganic microparticles A, and a mixture of the thermoplastic resin and inorganic microparticles B was kneaded, the kneading time being changed as above. The volume fraction Φ of the inorganic microparticles B to the thermoplastic resin was adjusted to be 0.3 in Sample 5, 0.2 in Samples 6 and 7, and 0.4 in Sample 8.

### (2.3) Preparation of Samples 9 Through 11

The same thermoplastic resin and melt kneading apparatus as used in item (2.1) above were used. Samples 9 through 11 were prepared in the same manner as in item (2.1) above, provided that inorganic microparticles C were used instead of inorganic microparticles A, and a mixture of the thermoplastic resin and inorganic microparticles C was kneaded, the kneading time being changed as above. The volume fraction Φ of the inorganic microparticles C to the thermoplastic resin was adjusted to be 0.3 in all of Samples 9 through 11.

### (2.4) Preparation of Samples 12 Through 14

The same thermoplastic resin and melt kneading apparatus as used in item (2.1) above were used. Samples 12 through 14 were prepared in the same manner as in item (2.1) above, provided that inorganic microparticles D were used instead of inorganic microparticles A, and a mixture of the thermoplastic resin and inorganic microparticles D was kneaded, the kneading time being changed as above. The volume fraction Φ of the inorganic microparticles D to the thermoplastic resin was adjusted to be 0.3 in all of Samples 12 through 14.

### (3) Evaluation of Samples

### (3.1) Measurement of Particle Diameter Distribution and Center-to-Center Distance Distribution of Inorganic Microparticles

Small angle X-ray scattering measurement was carried out employing a small and wide X-ray diffraction device (RINT2500/PC produced by Rigaku Denki Co., Ltd.). Thus, the particle diameter distribution and center-to-center distance distribution of the dispersion particles of the inorganic microparticles A, B, C and D in the resin of each of Samples 1 through 14 were determined. The measurement was carried out according to a transmittance method under the conditions described later. The thickness of each of Samples 1 through 14 was adjusted to be 1/μ (μ represents a mass absorption coefficient of each of Samples 1 through 14).

### Target; Copper

Output; 40 kV-200 mA

### 1st Slit: 0.04 mm

### 2nd Slit: 0.03 mm

### Light Receiving Slit: 0.1 mm

### Scattering Slit: 0.2 mm

### Measuring Method: 2θ FT Scanning Method

### Measuring Range: 0.1-6°

### Sampling: 0.04°

Computing time: 30 seconds

Each of Samples 1 through 14 was analyzed based on the resulting scattering pattern, employing an analysis soft (NANO-solver Ver3.0 produced by Rigaku Denki Co., Ltd.). Herein, a blank data necessary to analyze was obtained by measurement under the same condition as above, each of samples 1 through 14 being provided on the incident side of the light receiving slit box.

The analysis was carried out in which the blank data was removed, and slit correction was carried out, followed by fitting, thus, the particle diameter distribution and center-to-center distance distribution of the dispersion particles of the inorganic microparticles A, B, C and D in the resin of each of Samples 1 through 14 were determined. A value of D₅₀ was determined from the resulting particle diameter distribution, and a value of Lp and L₉₅ from the resulting center-to-center distance distribution. The results are shown in Table 2 described later.

### (3.2) Measurement of Light Transmittance

Each of Samples 1 through 14 was heat-melted and molded into the form of the plate with a thickness of 3 mm. With respect to each of Samples 1 through 14 in the form of the plate, light transmittance at wavelength 588 nm in the thickness direction was determined employing a spectrophotometer (UV-3150 produced by Shimazu Seisakusho Co., ltd.). The results are shown in Table 2 described later.

(3.3) Calculation of dn/dT Variation Rate

The refractive index at wavelength 588 nm of each of Samples 1 through 14 was measured employing an automatic refractometer (KPR-200 produced by Kalnew Optical Industrial Co., Ltd.) while the temperature of the samples was changed from 10 to 60° C. Then, dn/dT of each of Sample 1 through 14 was determined. Dn/dT of the thermoplastic resin (the resin of chemical formula 2 in Table 1), in which none of inorganic microparticles were dispersed, was determined in the same manner as above. The dn/dT variation rate of each of Samples through 14 was calculated based on the above results according to the following equation. The results are shown in Table 2.

dn/dT Variation Rate=(dn/dT of the thermoplastic resin−dn/dT of each of Samples 1 through 14)×100/(dn/dT of the thermoplastic resin)

TABLE 2

| Sample | | Inorganic Microparticles | | | | | | | | |
|---|---|---|---|---|---|---|---|---|---|---|
| No. | Resin | Kinds | Dp | Φ | D₅₀ | Lp | L₉₅ | ii) | iii) | Remarks |
| 1 | i) | A | 7 | 0.3 | 9 | 12 | 22 | 82 | 42 | Inv. |
| 2 | | | | | 17 | 19 | 30 | 76 | 36 | Inv. |
| 3 | | | | | 34 | 28 | 47 | 66 | 25 | Comp. |
| 4 | | | | 0.2 | 28 | 31 | 50 | 65 | 21 | Comp. |
| 5 | | B | 12 | 0.3 | 18 | 19 | 33 | 76 | 39 | Inv. |
| 6 | | | | 0.2 | 20 | 24 | 44 | 72 | 29 | Inv. |
| 7 | | | | | 24 | 28 | 65 | 70 | 27 | Inv. |
| 8 | | | | 0.4 | 19 | 15 | 28 | 78 | 45 | Inv. |
| 9 | | C | 17 | 0.3 | 22 | 21 | 35 | 82 | 34 | Inv. |
| 10 | | | | | 24 | 23 | 47 | 79 | 30 | Inv. |
| 11 | | | | | 29 | 32 | 75 | 67 | 20 | Comp. |
| 12 | | D | 7 | | 9 | 12 | 22 | 86 | 42 | Inv. |
| 13 | | | | | 17 | 19 | 30 | 84 | 36 | Inv. |
| 14 | | | | | 28 | 31 | 50 | 68 | 21 | Comp. |

Inv.: Inventive,
Comp.: Comparative
i) Thermoplastic Resin (Table 1 (2))
ii) Light Transmittance (%)
iii) dn/dT Variation Rate

As is apparent from Table 2, Samples 1, 2, 5 through 10, 12 and 13, which satisfy the condition defined by formulas (1) and (2), provide high light transmittance and high dn/dT variation rate, as compared with Samples 3, 4, 11 and 14, which do not satisfy the condition defined by formula (1) or (2). Therefore, it has proved that Samples 1, 2, 5 through 10, 12 and 13 are optically excellent organic-inorganic composite materials with low temperature dependency of the refractive index and high transparency.

### Example 2

### (1) Provision and Preparation of Inorganic Microparticles

Inorganic Microparticles A, B, C and D were prepared in the same manner as in Example 1.

### (2) Preparation of Samples

### (2.1) Preparation of Samples 15 Through 18

Inorganic Microparticles A were added to a mixture of 100 parts by weight of 3,4-epoxycyclohexenylmethyl-3′,4′-epoxycyclohexene carboxylate (Celoxide 2021 produced by Daicel Kagaku Kogyo Co., Ltd.) as a curable resin, 100 parts by weight of methyhexahydrophthalic anhydride (Epichrone B-650 produced by Dainippon Inki Kagaku Kogyo Co., Ltd.) as a curing agent, 3 parts by weight of 2-ethyl-4-methylimidazole (2E4MZ produced by Shikoku Kasei Kogyo Co., Ltd.) as a cure accelerating agent, 0.1 parts by weight of a phenol type anti-oxidant as a stabilizer (tetrakis(methylene-3-(3′,5′-di-t-butyl-4′-hydroxyphenylpropionate)methane) and 0.1 parts by weight of a phosphor type stabilizer (2,2′-methylenebis(4,6-di-t-butyl-phenyl)-2-ethylhexyl phosphite), and subjected to dispersion processing employing a table type three roll mill (RM-1 produced by Irie Shokai Co., Ltd.).

The resulting dispersion mixture was degassed in an automatic rotation system mixer (Awatori Rentaro AR-100 produced by THINKY Co., Ltd.), introduced in a mold, cured at 100° C. for 3 hours, and further cured in an oven at 140° C. for 3 hours, whereby colorless and transparent cured materials were obtained. The dispersion processing time in the roll mill was changed from 1 to 10. Thus, Samples 15 through 18 having a different dispersion degree were prepared. The volume fraction Φ of Inorganic Microparticles A to the curable resin was adjusted to be 0.3 in Samples 15 through 17 and 0.2 in Sample 18.

### (2.2) Preparation of Samples 19 Through 22

Samples 19 through 22 were prepared in the same manner as item (2.1) above, except that Inorganic Microparticles B were used instead of Inorganic Microparticles A. The volume fraction Φ of Inorganic microparticles B to the curable resin was adjusted to be 0.3 in Sample 19, 0.2 in Sample 20, 0.4 in Sample 21, and 0.5 in Sample 22.

### (2.3) Preparation of Samples 23 Through 25

Samples 23 through 25 were prepared in the same manner as item (2.1) above, except that Inorganic Microparticles C were used instead of Inorganic Microparticles A. The volume fraction Φ of Inorganic microparticles C to the curable resin was adjusted to be 0.4 in all of Samples 23 through 25.

### (2.4) Preparation of Samples 26 Through 28

Samples 26 through 28 were prepared in the same manner as item (2.1) above, except that Inorganic Microparticles D were used instead of Inorganic Microparticles A. The volume fraction Φ of Inorganic microparticles C to the curable resin was adjusted to be 0.3 in all of Samples 26 through 28.

### (3) Evaluation of Samples

Each of Samples 15 through 28 was evaluated in the same manner as in Example 1. The results are shown in Table 3.

Each of Samples 15 through 28 was cut to be in the form of the plate with a thickness of 3 mm, and the light transmittance was measured. With respect to the dn/dT variation rate, the dn/dT variation rate of each of Samples 1 through 14 to cured resin in which none of Inorganic Microparticles A, B, C and D were dispersed was determined,

TABLE 3

| Sample | | Inorganic Microparticles | | | | | | | | |
|---|---|---|---|---|---|---|---|---|---|---|
| No. | Resin | Kinds | Dp | Φ | D₅₀ | Lp | L₉₅ | ii) | iii) | Remarks |
| 15 | i) | A | 7 | 0.3 | 10 | 13 | 22 | 85 | 43 | Inv. |
| 16 | | | | | 17 | 19 | 30 | 82 | 37 | Inv. |
| 17 | | | | | 32 | 28 | 47 | 67 | 25 | Comp. |
| 18 | | | | 0.2 | 29 | 33 | 58 | 64 | 15 | Comp. |
| 19 | | B | 12 | 0.3 | 18 | 19 | 32 | 80 | 39 | Inv. |
| 20 | | | | 0.2 | 23 | 27 | 44 | 71 | 27 | Inv. |
| 21 | | | | 0.4 | 20 | 18 | 30 | 83 | 45 | Inv. |
| 22 | | | | 0.5 | 19 | 15 | 28 | 84 | 53 | Inv. |
| 23 | | C | 17 | 0.4 | 20 | 21 | 34 | 80 | 44 | Inv. |
| 24 | | | | | 22 | 23 | 45 | 76 | 40 | Inv. |
| 25 | | | | | 26 | 32 | 65 | 64 | 19 | Comp. |
| 26 | | D | 7 | 0.3 | 9 | 11 | 21 | 87 | 42 | Inv. |
| 27 | | | | | 18 | 19 | 29 | 83 | 36 | Inv. |
| 28 | | | | | 27 | 31 | 51 | 66 | 20 | Comp. |

Inv.: Inventive,
Comp.: Comparative
i) Curable Resin (Celoxide 2021)
ii) Light Transmittance (%)
iii) dn/dT Variation Rate

As is apparent from Table 3, Samples 15, 16, 19 through 24, 26 and 27, which satisfy the condition defined by formulas (1) and (2), provide high light transmittance and high dn/dT variation rate, as compared with Samples 17, 18, and 28, which do not satisfy the condition defined by formulas (1) and (2). Therefore, it has proved that Samples 15, 16, 19 through 24, 26 and 27 are optically excellent organic-inorganic composite materials with low temperature dependency of the refractive index and high transparency.

1.-6. (canceled)

7. An organic-inorganic composite material comprising a resin and inorganic microparticles dispersed therein, the inorganic microparticles being dispersed in the resin to form dispersion particles in the form of primary particles or in the form in which several primary particles are aggregated, wherein when particle diameter of the dispersion particles is expressed by D and center-to-center distance between the centers of any of the dispersion particles and a dispersion particle adjacent thereto is expressed by L, then the particle diameter D and the center-to-center distance L satisfy the conditions defined by the following formulas (1) and (2),
D₅₀≦30 nm (1)
wherein D₅₀ represents the particle diameter in a number distribution function of the dispersion particles at which the cumulative number reaches 50% of the number of all the dispersion particles, Formula (2)
L_{P}≦30 nm (2)
wherein L_{P} represents the center-to-center distance providing a peak in a frequency distribution function of the center-to-center distance L.

8. The organic-inorganic composite material of claim 7, further satisfying the following formula (3),
L_{P}≦20 nm (3)

9. The organic-inorganic composite material of claim 7, further satisfying the following formula (4),
L₉₅≦60 nm (4)
wherein L₉₅ represents the center-to-center distance providing a cumulative frequency of 95% in the frequency distribution function of the center-to-center distances L.

10. The organic-inorganic composite material of claim 7, further satisfying the following formula (5),
0.2≦Φ≦0.6 (5)
wherein Φ represents the volume fraction of the inorganic microparticles in the organic-inorganic composite material.

11. The organic-inorganic composite material of claim 7, wherein the inorganic microparticles are particles of composite oxides comprised of silicon oxide and an oxide of one or more kinds of metals other than silicon.

12. An optical element formed from the organic-inorganic composite material of claim 7.
